(19) United States
(12) Patent Application Publication
(10) Pub. No.: US 2020/0348220 A1
(43) Pub. Date: Nov. 5, 2020

(54) PARTICLE DETECTION DEVICE

(71) Applicant: NGK INSULATORS, LTD., Nagoya-City (JP)

(72) Inventors: Keiichi KANNO, Nagoya-City (JP); Hidemasa OKUMURA, Nagoya-City (JP); Kazuyuki MIZUNO, Nagoya-City (JP)

(73) Assignee: NGK INSULATORS, LTD., Nagoya-City (JP)

(21) Appl. No.: 16/929,635

(22) Filed: Jul. 15, 2020

Related U.S. Application Data
(63) Continuation of application No. PCT/JP2019/002562, filed on Jan. 25, 2019.

(30) Foreign Application Priority Data
Feb. 8, 2018 (JP) 2018-021097
Sep. 20, 2018 (JP) 2018-175737

(51) Int. Cl. G01N 15/06; G01N 27/68; G01N 21/67; B03C 3/45

(52) U.S. Cl. CPC G01N 15/0606; G01N 27/68; B03C 3/45; G01N 21/67; G01N 15/0656

(57) ABSTRACT

A particle detection device includes a ceramic housing, a charge generator that adds electric charge generated in accordance with electric discharge to particles in gas introduced into a gas channel so as to turn the particles into charged particles, a collector that collects the charged particles, and a number measuring device that detects the number of particles based on an electric current that changes in accordance with the charged particles collected by the collector. The collector has a collection electrode exposed in the gas channel and a counter electrode facing the collection electrode with the gas channel interposed therebetween. The housing has a guard electrode that absorbs a leakage current flowing from the counter electrode toward the collection electrode via the housing.

### BACKGROUND OF THE INVENTION

### 1. Field of the Invention

The present invention relates to particle detection devices.

### 2. Description of the Related Art

A known particle detection device includes a ceramic housing having a gas channel, a charge generator that adds electric charge generated in accordance with electric discharge to particles in gas introduced into the gas channel so as to turn the particles into charged particles, a collector that is provided downstream of the charge generator within the gas channel and that collects the charged particles, and a number measuring unit that measures the number of particles based on the amount of electric charge in the collected charged particles (e.g., see Patent Literature 1). The collector has a collection electrode exposed in the gas channel and a counter electrode facing the collection electrode with the gas channel interposed therebetween. The collection electrode collects the charged particles by utilizing an electric field generated in the gas channel between the collection electrode and the counter electrode by applying a voltage between the collection electrode and the counter electrode. The amount of electric charge in the collected charged particles is detected as a minute electric current (e.g., several pA).

### CITATION LIST

### Patent Literature

PTL 1: PCT International Publication No. WO 2015/146456 Pamphlet

### SUMMARY OF THE INVENTION

However, when a voltage is applied between the collection electrode and the counter electrode, a small amount of leakage current flows from one of the collection electrode and the counter electrode to the other via the ceramic housing, and the leakage current may have an effect on a minute detection current corresponding to the amount of charged particles collected by the collection electrode. Thus, it is difficult to enhance the accuracy for detecting the amount of particles.

The present invention has been made to solve the aforementioned problem, and a main object thereof is to enhance the accuracy for detecting the amount of particles.

In order to achieve the main object mentioned above, the present invention employs the following solutions.

A particle detection device according to the present invention is used for detecting particles in gas and includes: a housing having a gas channel through which the gas passes; a charge generator that adds electric charge generated in accordance with electric discharge to the particles in the gas introduced into the gas channel so as to turn the particles into charged particles; a collector that is provided downstream, in a flow of the gas, of the charge generator within the gas channel and that collects a collection target, the collection target being either of the charged particles or excess electric charge that has not charged the particles; and a detector that detects an amount of the particles based on a physical amount that changes in accordance with the collection target collected by the collector. The collector has a collection electrode exposed in the gas channel and a counter electrode facing the collection electrode with the gas channel interposed therebetween, and collects the collection target onto the collection electrode by utilizing an electric field generated between the collection electrode and the counter electrode in the gas channel by applying a voltage between the collection electrode and the counter electrode. The housing has a leakage-current absorbing electrode that absorbs a leakage current flowing from one of the collection electrode and the counter electrode to the other one of the collection electrode and the counter electrode via the housing.

In this particle detection device, the charge generator generates electric charge so as to turn the particles in the gas introduced in the gas channel into charged particles, and the collector collects the collection target, which is either of the charged particles or the excess electric charge. The detector detects the amount of particles based on the physical amount that changes in accordance with the collection target collected by the collector. The leakage-current absorbing electrode absorbs the leakage current flowing from one of the collection electrode and the counter electrode to the other via the housing. Such a leakage current has an effect on the physical amount that changes in accordance with the collection target collected by the collector, but is absorbed by the leakage-current absorbing electrode. Therefore, the physical amount that changes in accordance with the collection target collected by the collector can be accurately ascertained, whereby the accuracy for detecting the amount of particles can be enhanced.

In this description, “electric charge” includes ions in addition to positive electric charge and negative electric charge. A “physical amount” may be a parameter that changes in accordance with the collection target, and may be, for example, an electric current. An “amount of particles” is, for example, the number, mass, or surface area of particles.

In the particle detection device according to the present invention, the leakage-current absorbing electrode may be connected to ground. Accordingly, the leakage current can be reliably discharged outside. The ground may be a frame ground, such as a metallic case or a chassis, or may be the earth.

In the particle detection device according to the present invention, the leakage-current absorbing electrode may be provided so as to block an electric current path connecting the collection electrode and the counter electrode within the housing. Accordingly, the leakage current can be reliably absorbed. In this case, at least a part of the electric current path may be composed of a ceramic material, and the leakage-current absorbing electrode may be provided at the part composed of the ceramic material. Although the part composed of the ceramic material has high volume resistivity, a small amount of electric current may possibly flow therethrough. Therefore, there is significance in providing that part with the leakage-current absorbing electrode. Furthermore, the leakage-current absorbing electrode may be provided from the part composed of the ceramic material to an inner surface of the housing, or may be provided from the part composed of the ceramic material to the inner surface of the housing and to an outer surface of the housing. Accordingly, the leakage-current absorbing electrode can absorb a leakage current flowing through the interior of the housing and a leakage current flowing along the inner surface of the housing (i.e., the surface exposed in the gas channel), and can further absorb a leakage current flowing along the outer surface of the housing.

In the particle detection device according to the present invention, the leakage-current absorbing electrode may be provided at an inner surface of the housing. Accordingly, a leakage current flowing along the inner surface of the housing can be absorbed. In this case, the leakage-current absorbing electrode may be provided at the same surface as the collection electrode such that the leakage-current absorbing electrode surrounds the collection electrode. Accordingly, a leakage current flowing along the inner surface of the housing can be reliably prevented from flowing to the collection electrode.

In the particle detection device according to the present invention, if the leakage-current absorbing electrode is provided at the inner surface of the housing, the leakage-current absorbing electrode may be provided at a surface (such as a stepped surface) different from a surface where the collection electrode is provided. Accordingly, even if electrically-conductive particles adhere to a surrounding area of the collection electrode, the particles are less likely to cause a short circuit to occur between the collection electrode and the leakage-current absorbing electrode.

In the particle detection device according to the present invention, the leakage-current absorbing electrode may be provided at positions above and below the collection electrode and extend from a gas inlet to a gas outlet of the gas channel. Accordingly, the leakage-current absorbing electrode can reliably absorb a leakage current flowing to the collection electrode. Furthermore, since the leakage-current absorbing electrode does not need to be provided in front of and behind the collection electrode, the collection electrode can be increased in size and can collect a larger number of charged particles, as compared with a case where the leakage-current absorbing electrode is provided to surround the entire periphery of the collection electrode. Thus, the measurement sensitivity is enhanced.

In the particle detection device according to the present invention, the collection target may be the charged particles. If the charged particles are to be collected by the collection electrode, the voltage to be applied between the collection electrode and the counter electrode needs to be high, as compared with a case where excess electric charge is to be collected by the collection electrode. Thus, a leakage current flows readily from the one of the collection electrode and the counter electrode toward the other via the housing. Therefore, there is great significance in providing the leakage-current absorbing electrode.

The particle detection device according to the present invention in which the collection target is the charged particles may further include a removal electrode that is provided between the charge generator and the collector within the gas channel and that removes the excess electric charge that has not charged the particles to ground, and the leakage-current absorbing electrode may be integrated with the removal electrode. Accordingly, the configuration of the electrodes can be simplified. Furthermore, without having a dedicated power source that generates an electric field on the removal electrode, the removal electrode may remove the excess electric charge to the ground by utilizing an electric field generated between the removal electrode and a voltage application electrode disposed in a surrounding area of the removal electrode. Accordingly, the configuration of the particle detection device can be simplified, as compared with a case where the removal electrode has a dedicated power source for generating an electric field. Moreover, the voltage application electrode may be a discharge electrode that receives a voltage applied by a discharge power source in the charge generator, or may be the counter electrode that receives a voltage applied by a collection power source in the collector. Accordingly, a discharge power source or a collection power source may be used in place of a dedicated power source for the removal electrode.

### BRIEF DESCRIPTION OF THE DRAWINGS

FIG. 1 illustrates a particle detection device 10.

FIG. 2 is a perspective view of a particle detection element 20.

FIG. 3 is a cross-sectional view taken along line A-A in FIG. 2.

FIG. 4 is a cross-sectional view taken along line B-B in FIG. 2.

FIG. 5 is a cross-sectional view taken along line C-C in FIG. 2.

FIG. 6 is an exploded perspective view of the particle detection element 20.

FIG. 7 is an exploded perspective view of a particle detection element 120.

FIG. 8 is a cross-sectional view of a particle detection element 220.

FIG. 9 is a cross-sectional view of the particle detection element 220.

FIG. 10 is a cross-sectional view of the particle detection element 220.

FIG. 11 is a cross-sectional view of a particle detection element 320.

FIG. 12 is a cross-sectional view of a particle detection element 420.

FIG. 13 is a cross-sectional view taken along line D-D in FIG. 12.

FIG. 14 is a cross-sectional view taken along line E-E in FIG. 12.

FIG. 15 is a cross-sectional view taken along line F-F in FIG. 12.

FIG. 16 is an exploded perspective view of the particle detection element 420.

FIG. 17 is a cross-sectional view (corresponding to the cross-sectional view taken along line E-E in FIG. 12) of another example of the particle detection element 420.

FIGS. 18A and 18B include cross-sectional views of the particle detection element 20 equipped with guard electrodes 290 and 292.

FIGS. 19A and 19B include cross-sectional views of the particle detection element 20 equipped with guard electrodes 390 and 392.

### DETAILED DESCRIPTION OF THE INVENTION

### First Embodiment

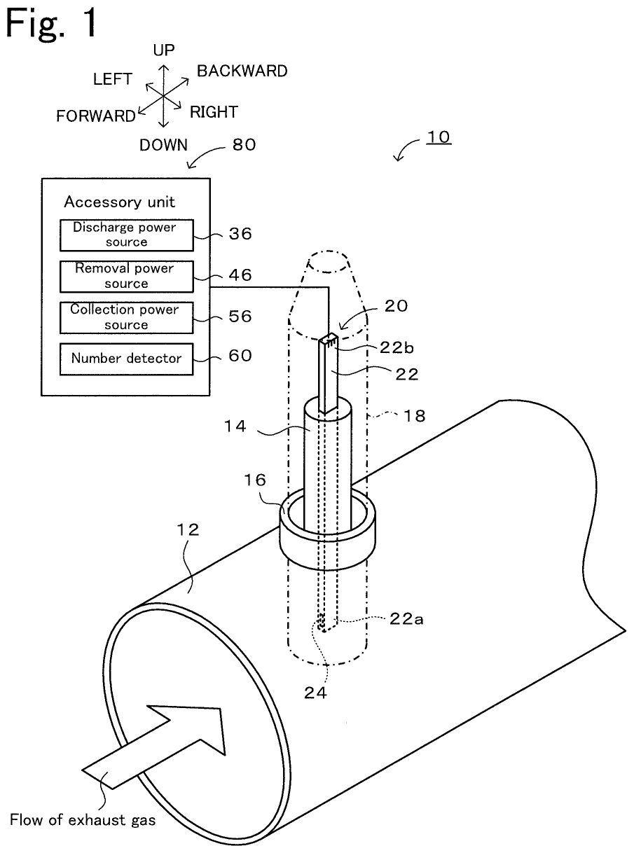

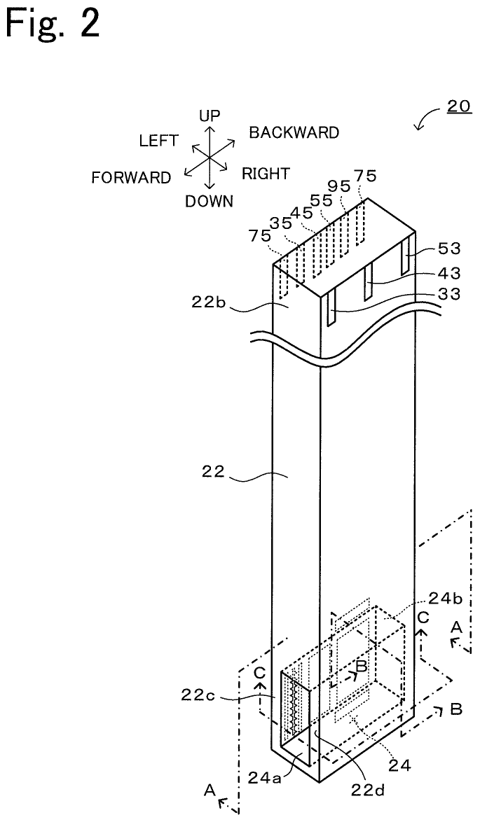

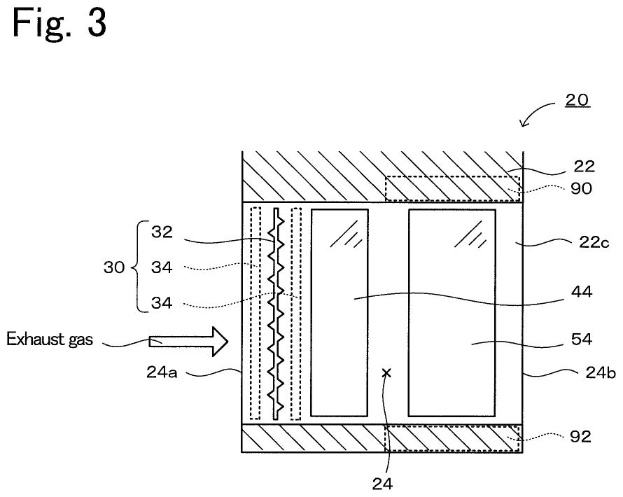

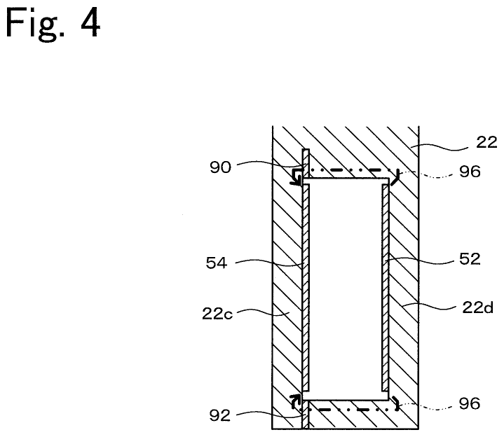

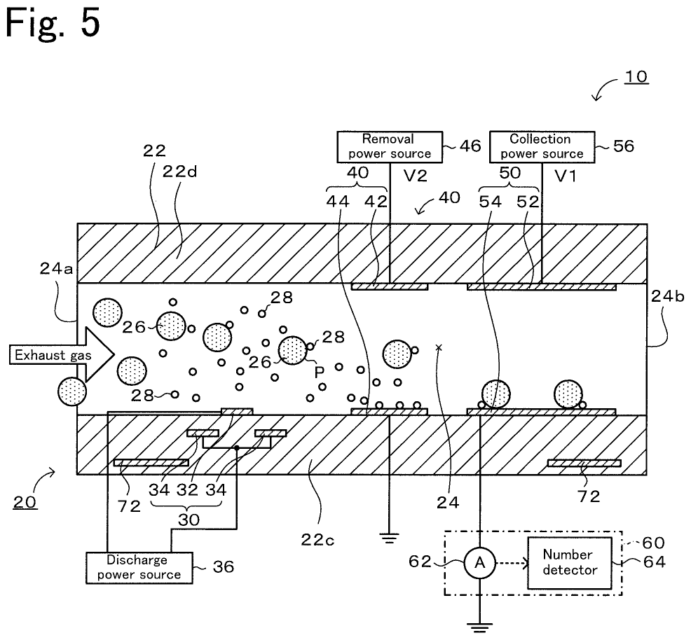

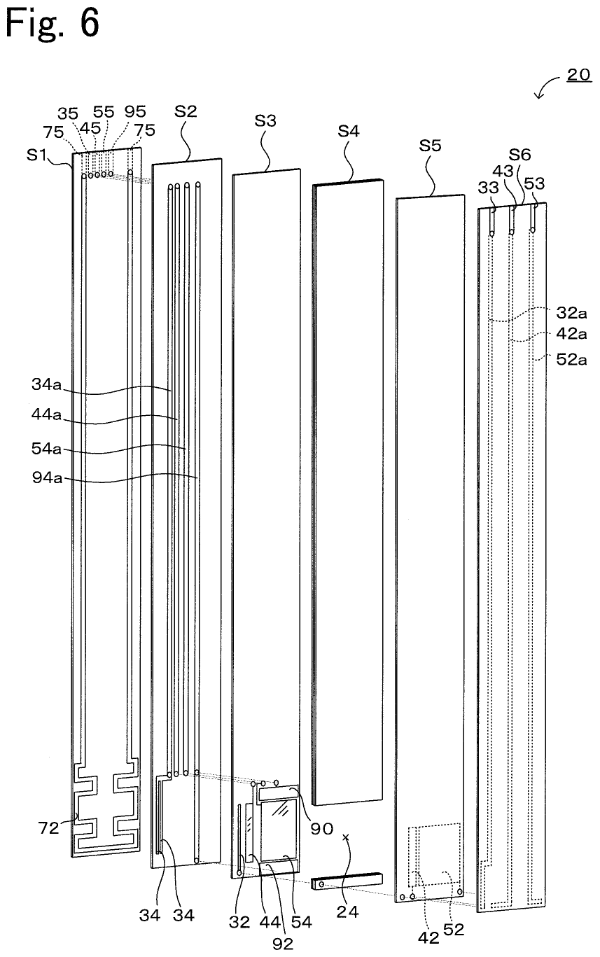

A first embodiment of the present invention will be described with reference to the drawings. FIG. 1 illustrates a particle detection device 10 according to a first embodiment, FIG. 2 is a perspective view of a particle detection element 20, FIG. 3 is a cross-sectional view taken along line A-A in FIG. 2, FIG. 4 is a cross-sectional view taken along line B-B in FIG. 2, FIG. 5 is a cross-sectional view taken along line C-C in FIG. 2, and FIG. 6 is an exploded perspective view of the particle detection element 20. In this embodiment, the up-down direction, the left-right direction, and the front-rear direction are as shown in FIGS. 1 and 2.

As shown in FIG. 1, the particle detection device 10 detects the number of particles 26 (see FIG. 5) contained in exhaust gas flowing through an exhaust pipe 12 of an engine. The particle detection device 10 is equipped with the particle detection element 20 and an accessory unit 80 including various types of power sources 36, 46, and 56 and a number detector 60.

As shown in FIG. 1, in a state where the particle detection element 20 is inserted in a cylindrical supporter 14, the particle detection element 20 is attached to a ring-shaped base 16 fixed to the exhaust pipe 12. The particle detection element 20 is protected by a protection cover 18. The protection cover 18 is provided with a hole (not shown), and the exhaust gas flowing through the exhaust pipe 12 passes through a gas channel 24, provided at a lower end 22a of the particle detection element 20, via this hole. As shown in FIG. 5, in a housing 22, the particle detection element 20 includes a charge generator 30, an excess charge remover 40, a collector 50, guard electrodes 90 and 92 (see FIGS. 3 and 4), and a heater electrode 72.

As shown in FIG. 1, the housing 22 has a long rectangular-cuboid body that is long in a direction intersecting (i.e., substantially orthogonal to) the axial direction of the exhaust pipe 12. The housing 22 is composed of, for example, a ceramic material, such as alumina. The lower end 22a of the housing 22 is disposed inside the exhaust pipe 12, and an upper end 22b is disposed outside the exhaust pipe 12. The lower end 22a of the housing 22 is provided with the gas channel 24. The upper end 22b of the housing 22 is provided with various types of terminals.

The axial direction of the gas channel 24 is aligned with the axial direction of the exhaust pipe 12. As shown in FIG. 2, the gas channel 24 is a rectangular-cuboid space extending continuously from a rectangular gas inlet 24a provided at the front surface of the housing 22 to a rectangular gas outlet 24b provided at the rear surface of the housing 22. The housing 22 has a pair of left and right channel walls 22c and 22d that constitute the gas channel 24.

As shown in FIGS. 3 and 5, the charge generator 30 is provided at the channel wall 22c such that electric charge is generated near the gas inlet 24a in the gas channel 24. The charge generator 30 has a discharge electrode 32 and two ground electrodes 34, 34. The discharge electrode 32 is provided along the inner surface of the channel wall 22c and has a plurality of fine protrusions in a rectangular surrounding area, as shown in FIG. 3. The two ground electrodes 34, 34 are rectangular electrodes, are embedded apart from each other in the channel wall 22c, and are parallel to the discharge electrode 32. As shown in FIG. 5, in the charge generator 30, a pulse voltage of several kV from the discharge power source 36 (which is one of the components of the accessory unit 80) is applied between the discharge electrode 32 and the two ground electrodes 34, 34, so that aerial discharge caused by a potential difference between the electrodes is generated. In this case, a part of the housing 22 between the discharge electrode 32 and the ground electrodes 34, 34 functions as a dielectric layer. This aerial discharge causes the gas surrounding the discharge electrode 32 to be ionized, so that positive electric charge 28 is generated. The discharge electrode 32 is connected to a terminal 33 at the upper end 22b of the housing 22, and is connected to the discharge power source 36 via this terminal 33. Furthermore, the two ground electrodes 34, 34 are connected to a terminal 35 at the upper end 22b of the housing 22, and are connected to the discharge power source 36 via this terminal 35.

As shown in FIG. 5, the particles 26 contained in the gas enter the gas channel 24 from the gas inlet 24a, turn into charged particles P by receiving the electric charge 28 generated in accordance with the aerial discharge in the charge generator 30 as the particles 26 pass through the charge generator 30, and then move rearward. Some of the generated electric charge 28 not added to the particles 26 move rearward while remaining as the electric charge 28.

As shown in FIG. 5, the excess charge remover 40 is provided downstream of the charge generator 30 and upstream of the collector 50. The excess charge remover 40 has an application electrode 42 and a removal electrode 44. The application electrode 42 is provided along the inner surface of the right channel wall 22d, and is exposed within the gas channel 24. The removal electrode 44 is provided along the inner surface of the left channel wall 22c, and is exposed within the gas channel 24. The application electrode 42 and the removal electrode 44 are disposed at positions facing each other. The application electrode 42 receives a voltage V2 (positive potential) lower than a voltage V1, to be described later, by about one digit from the removal power source 46 (which is one of the components of the accessory unit 80). The removal electrode 44 is connected to ground. The ground may be a frame ground, such as the protection cover 18 or the exhaust pipe 12, or may be the earth (the same applies hereinafter). Accordingly, a weak electric field is generated between the application electrode 42 and the removal electrode 44 of the excess charge remover 40. Therefore, of the electric charge 28 generated by the charge generator 30, excess electric charge 28 not added to the particles 26 is collected by being drawn to the removal electrode 44 by this weak electric field, and is discarded to the ground. Consequently, the excess charge remover 40 suppresses a situation where the excess electric charge 28 is collected by a collection electrode 54 of the collector 50 and is added to the count number of particles 26. The application electrode 42 is connected to a terminal 43 at the upper end 22b of the housing 22, and is connected to the removal power source 46 via this terminal 43. The removal electrode 44 is connected to a terminal 45 at the upper end 22b of the housing 22, and is connected to ground via this terminal 45.

As shown in FIG. 5, the collector 50 is provided downstream of the charge generator 30 and the excess charge remover 40 in the gas channel 24. The collector 50 collects the charged particles P and has a counter electrode (electric-field generating electrode) 52 and the collection electrode 54. The counter electrode 52 is provided along the inner surface of the right channel wall 22d, and is exposed within the gas channel 24. The collection electrode 54 is provided along the inner surface of the left channel wall 22c, and is exposed within the gas channel 24. The counter electrode 52 and the collection electrode 54 are disposed at positions facing each other. The counter electrode 52 receives, from the collection power source 56 (which is one of the components of the accessory unit 80), the voltage V1 (positive potential) larger than the voltage V2 applied to the application electrode 42. The collection electrode 54 is connected to ground via an ammeter 62. Accordingly, a relatively strong electric field is generated between the counter electrode 52 and the collection electrode 54 of the collector 50. Therefore, the charged particles P flowing through the gas channel 24 are collected by being drawn to the collection electrode 54 by this relatively strong electric field. The counter electrode 52 is connected to a terminal 53 at the upper end 22b of the housing 22, and is connected to the collection power source 56 via this terminal 53. The collection electrode 54 is connected to a terminal 55 at the upper end 22b of the housing 22, and is connected to the ammeter 62 via this terminal 55.

The sizes of the electrodes 42 and 44 of the excess charge remover 40, the intensity of the electric field generated between the electrodes 42 and 44, the sizes of the electrodes 52 and 54 of the collector 50, and the intensity of the electric field generated between the electrodes 52 and 54 are set such that the charged particles P are collected by the collection electrode 54 without being collected by the removal electrode 44 and such that the electric charge 28 not added to the particles 26 is removed by the removal electrode 44. Normally, these settings are easily possible since the degree of electrical migration of the electric charge 28 is 10 or more times the degree of electrical migration of the charged particles P and the electric field required for the collection may be smaller by one or more digits. With regard to the counter electrode 52 and the collection electrode 54, a plurality of sets thereof may be provided.

The guard electrodes 90 and 92 are rectangular flat electrodes and each serve as a leakage-current absorbing electrode that absorbs a leakage current flowing from the counter electrode 52 toward the collection electrode 54 via the housing 22. In detail, the guard electrodes 90 and 92 are respectively provided above and below the collection electrode 54 so as to block an electric current path 96 (see a two-dot chain line in FIG. 4) connecting the collection electrode 54 and the counter electrode 52 within the housing 22. Because the housing 22 is composed of a ceramic material, a part of the electric current path 96 is composed of the ceramic material. The guard electrodes 90 and 92 are provided at the part composed of the ceramic material. The guard electrodes 90 and 92 are connected to ground. The guard electrodes 90 and 92 are connected to a terminal 95 at the upper end 22b of the housing, and are connected to ground via this terminal 95.

The number detector 60 is one of the components of the accessory unit 80 and includes the ammeter 62 and a number measuring device 64, as shown in FIG. 5. The ammeter 62 has one end connected to the collection electrode 54 and another end connected to ground. This ammeter 62 measures the electric current of the charged particles P collected by the collection electrode 54 based on the electric charge 28. The number measuring device 64 calculates the number of particles 26 based on the electric current measured by the ammeter 62.

The heater electrode 72 is a strip-shaped heating element embedded in the housing 22. In detail, the heater electrode 72 is wired such that the heater electrode 72 is routed in a zigzag pattern on the channel wall 22c of the housing 22 from one of terminals 75 (see FIG. 2) at the upper end 22b of the housing 22 and subsequently returns to another terminal 75 (see FIG. 2) at the upper end 22b of the housing 22. A specific shape of the heater electrode 72 is shown in FIG. 6. The heater electrode 72 is connected to an electricity feeder (not shown) via the pair of terminals 75, 75 and generates heat by being supplied with electricity from the electricity feeder. The heater electrode 72 heats the housing 22 as well as electrodes, such as the removal electrode 44 and the collection electrode 54.

The configuration of the particle detection element 20 will be further described by using the exploded perspective view in FIG. 6. The particle detection element 20 is constituted of six sheets S1 to S6. The sheets S1 to S6 are composed of the same material as the housing 22. For the sake of convenience, the sheets will be referred to as a first sheet S1, a second sheet S2, and so on from left to right, and the right face and the left face of each of the sheets S1 to S6 will be referred to as a front face and a rear face, respectively. The sheets S1 to S6 may each have an appropriately-set thickness. For example, the thickness may be the same among the sheets or may vary among the sheets.

The front face of the first sheet S1 is provided with the heater electrode 72. One end and the other end of the heater electrode 72 are disposed at the upper side of the front face of the first sheet S1, and are respectively connected to the heater-electrode terminals 75, 75 provided at the upper side of the rear face of the first sheet S1 via through-holes in the first sheet S1.

The front face of the second sheet S2 is provided with the ground electrodes 34, 34. The ground electrodes 34, 34 are bundled into a single wire 34a. An end of the wire 34a is disposed at the upper side of the front face of the second sheet S2, and is connected to the ground-electrode terminal 35, provided at the upper side of the rear face of the first sheet S1, via through-holes in the second sheet S2 and the first sheet S1. The front face of the second sheet S2 is provided with a wire 44a of the removal electrode 44, a wire 54a of the collection electrode 54, and a wire 94a of the guard electrodes 90 and 92 in the up-down direction. The upper ends of the wire 44a, the wire 54a, and the wire 94a are respectively connected to the removal-electrode terminal 45, the collection-electrode terminal 55, and the guard-electrode terminal 95, provided at the upper side of the rear face of the first sheet S1, via through-holes in the second sheet S2 and the first sheet S1.

The front face of the third sheet S3 is provided with the discharge electrode 32, the removal electrode 44, the collection electrode 54, and the guard electrodes 90 and 92. The removal electrode 44 is connected to the wire 44a in the second sheet S2 via a through-hole in the third sheet S3, and is further connected to the removal-electrode terminal 45 via this wire 44a. The collection electrode 54 is connected to the wire 54a in the second sheet S2 via a through-hole in the third sheet S3, and is further connected to the collection-electrode terminal 55 via this wire 54a. The guard electrodes 90 and 92 are connected to the wire 94a in the second sheet S2 via through-holes in the third sheet S3, and are further connected to the guard-electrode terminal 95 via this wire 94a.

The lower end of the fourth sheet S4 is provided with the gas channel 24, that is, a rectangular-cuboid-shaped space.

The rear face of the fifth sheet S5 is provided with the application electrode 42 and the counter electrode 52.

The rear face of the sixth sheet S6 is provided with a wire 32a of the discharge electrode 32, a wire 42a of the application electrode 42, and a wire 52a of the counter electrode 52 in the up-down direction. The lower end of the wire 32a is connected to the discharge electrode 32 provided in the third sheet S3 via through-holes in the fourth and fifth sheets S4 and S5. The lower end of the wire 42a is connected to the application electrode 42 provided at the rear face of the fifth sheet S5 via a through-hole in the fifth sheet S5. The lower end of the wire 52a is connected to the counter electrode 52 provided at the rear face of the fifth sheet S5 via a through-hole in the fifth sheet S5. The upper ends of the wires 32a, 42a, and 52a are respectively connected to the discharge-electrode terminal 33, the application-electrode terminal 43, and the counter-electrode terminal 53, provided at the upper side of the front face of the sixth sheet S6, via through-holes in the sixth sheet S6.

Next, an example of how the particle detection device 10 is manufactured will be described. The particle detection element 20 can be fabricated by using a plurality of ceramic green sheets. In detail, after forming cutouts, through-holes, and grooves in the plurality of ceramic green sheets and screen-printing electrodes and wiring patterns thereon, where appropriate, the ceramic green sheets are stacked and baked. The cutouts, the through-holes, and the grooves may be formed by filling in a material (such as an organic material) that burns out during the baking process. The particle detection element 20 is obtained in this manner. Subsequently, the discharge-electrode terminal 33, the application-electrode terminal 43, and the counter-electrode terminal 53 of the particle detection element 20 are respectively connected to the discharge power source 36, the removal power source 46, and the collection power source 56 of the accessory unit 80. The ground-electrode terminal 35, the removal-electrode terminal 45, and the guard-electrode terminal 95 of the particle detection element 20 are connected to ground, and the collection-electrode terminal 55 is connected to the number measuring device 64 via the ammeter 62. Furthermore, the heater-electrode terminals 75, 75 are connected to the electricity feeder (not shown). The particle detection device 10 can be manufactured in this manner.

Next, an example of how the particle detection device 10 is used will be described. In a case where particles 26 contained in exhaust gas of an automobile are to be measured, the particle detection element 20 is attached to the exhaust pipe 12 of the engine, as described above (see FIG. 1).

As shown in FIG. 5, the particles 26 contained in the exhaust gas introduced into the gas channel 24 from the gas inlet 24a are charged by the electric charge 28 (i.e., positive electric charge) generated in accordance with electric discharge by the charge generator 30, so as to become charged particles P. The charged particles P have a weak electric field and pass through the excess charge remover 40 in which the removal electrode 44 is shorter than the collection electrode 54, so as to reach the collector 50. On the other hand, electric charge 28 not added to the particles 26 has a weak electric field but is still drawn toward the removal electrode 44 of the excess charge remover 40, so as to be discarded to the ground via the removal electrode 44. Consequently, most of the unwanted electric charge 28 not added to the particles 26 do not reach the collector 50.

The charged particles P reaching the collector 50 are collected by the collection electrode 54 in accordance with a collection electric field generated by the counter electrode 52. Then, the ammeter 62 measures the electric current of the charged particles P collected by the collection electrode 54 based on the electric charge 28, and the number measuring device 64 calculates the number of particles 26 based on the electric current. The relationship between an electric current I and a charge amount q is expressed as I=dq/(dt), q=∫Idt. The number measuring device 64 integrates (accumulates) electric current values over a predetermined period to determine an integral value thereof (i.e., accumulative charge amount), divides the accumulative charge amount by elementary electric charge to determine the total number of electric charge particles (i.e., the number of collected electric charge particles), and divides the number of collected electric charge particles by an average value of the number of electric charge particles added to a single particle 26 (i.e., the average number of charged particles), thereby determining the number Nt of particles 26 collected by the collection electrode 54 (see Expression (1) indicated below). The number measuring device 64 detects this number Nt as the number of particles 26 in the exhaust gas.

Nt=(accumulative charge amount)/{(elementary electric charge)×(average number of charged particles)} (1)

For example, when many particles 26 deposit on the collection electrode 54 as the particle detection element 20 is used, a new charged particle or particles P may be not collected by the collection electrode 54. Therefore, the collection electrode 54 is heated by the heater electrode 72 on a regular basis or when the deposited amount reaches a predetermined amount, so that the deposit on the collection electrode 54 is heated and burned, thereby refreshing the electrode surface of the collection electrode 54. Moreover, the particles 26 adhered on the inner peripheral surface of the housing 22 may also be burned by the heater electrode 72.

Next, the function of the guard electrodes 90 and 92 will be described. When the number Nt is to be detected in the particle detection device 10, a voltage V1 is applied between the counter electrode 52 and the collection electrode 54 of the collector 50. Because the voltage V1 is several kV, a leakage current of several tens to several hundreds of pA flows between the counter electrode 52 and the collection electrode 54 through the electric current path 96 (see FIG. 4) in the housing 22, even if the housing 22 is composed of a ceramic material, such as alumina, normally considered to be an electrical insulator. Meanwhile, when the number Nt is to be detected, a detection current measured by the ammeter 62 is several pA. Therefore, the leakage current has an effect on the detection current. In this embodiment, the guard electrodes 90 and 92 are provided above and below the collection electrode 54 to block the electric current path 96 connecting the counter electrode 52 and the collection electrode 54 within the housing 22. These guard electrodes 90 and 92 are connected to ground. Therefore, the guard electrodes 90 and 92 absorb the leakage current flowing from the counter electrode 52 toward the collection electrode 54 via the housing 22 and discard the leakage current to the ground. Consequently, the detection current that changes in accordance with the charged particles P collected by the collection electrode 54 can be accurately ascertained.

In the particle detection device 10 described above, the leakage current flowing from the counter electrode 52 toward the collection electrode 54 via the housing 22 has an effect on the detection current that changes in accordance with the charged particles P collected by the collection electrode 54, but is absorbed by the guard electrodes 90 and 92. Therefore, the detection current can be accurately ascertained, whereby the accuracy for detecting the number of particles can be enhanced.

Furthermore, since the guard electrodes 90 and 92 are connected to ground, the leakage current can be reliably discharged outside.

Moreover, since the guard electrodes 90 and 92 are provided so as to block the electric current path 96 connecting the counter electrode 52 and the collection electrode 54 within the housing 22, the leakage current can be reliably absorbed. These guard electrodes 90 and 92 are embedded in the housing 22 composed of a ceramic material with high volume resistivity, such as alumina. Although the housing 22 has high volume resistivity, a small amount of leakage current may possibly flow therethrough since the voltage V1 applied between the counter electrode 52 and the collection electrode 54 is high at several kV. The electric current detected by the ammeter 62 is a small value and is thus affected by this small amount of leakage current. Therefore, there is significance in providing the guard electrodes 90 and 92 in the housing 22.

Furthermore, since the collection target to be collected is the charged particles P, the voltage V1 to be applied between the counter electrode 52 and the collection electrode 54 needs to be high, as compared with a case where the collection target is excess electric charge. Thus, the leakage current flows readily from the counter electrode 52 toward the collection electrode 54 via the housing 22, and there is great significance in absorbing the leakage current by using the guard electrodes 90 and 92.

Needless to say, the present invention is not limited in any way to the first embodiment described above and may be implemented in various modes within the technical scope of the invention.

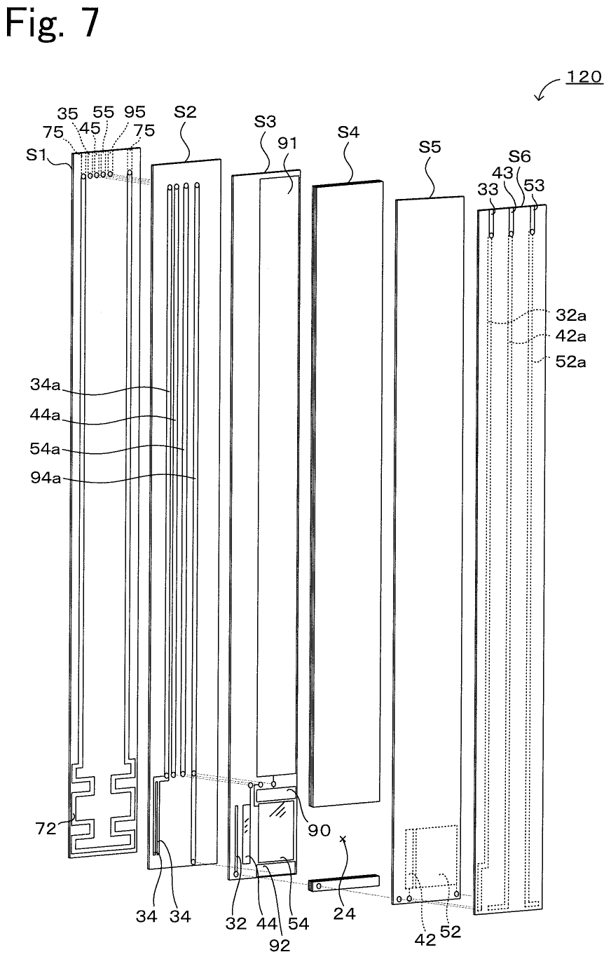

For example, in the first embodiment described above, a leakage current may possibly flow between the wire 52a of the counter electrode 52 and the wire 54a of the collection electrode 54. Therefore, a sub guard electrode 91 extending from the wire 52a to the wire 54a via the housing 22 may be provided within the housing, as in a particle detection element 120 shown in FIG. 7. In FIG. 7, components identical to those in the first embodiment described above are given the same reference signs. The sub guard electrode 91 is provided in the third sheet S3 in the up-down direction so as to be positioned between the wires 52a and 54a, and is connected to the guard electrode 90. Accordingly, since the leakage current flowing between the wires 52a and 54a within the housing is absorbed by the sub guard electrode 91 and is discarded to the ground, the accuracy for detecting the number of particles can be further enhanced. Such a sub guard electrode 91 may also be employed in a second embodiment to be described later.

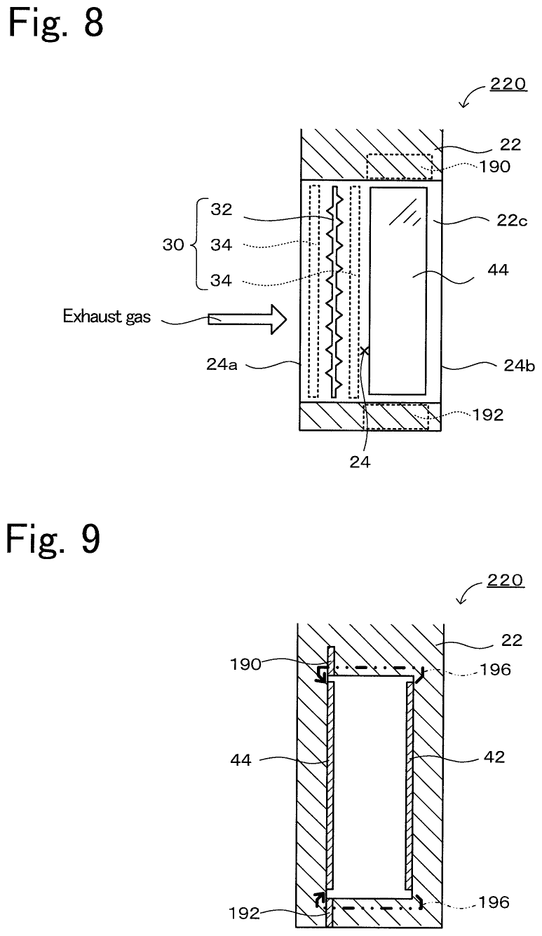

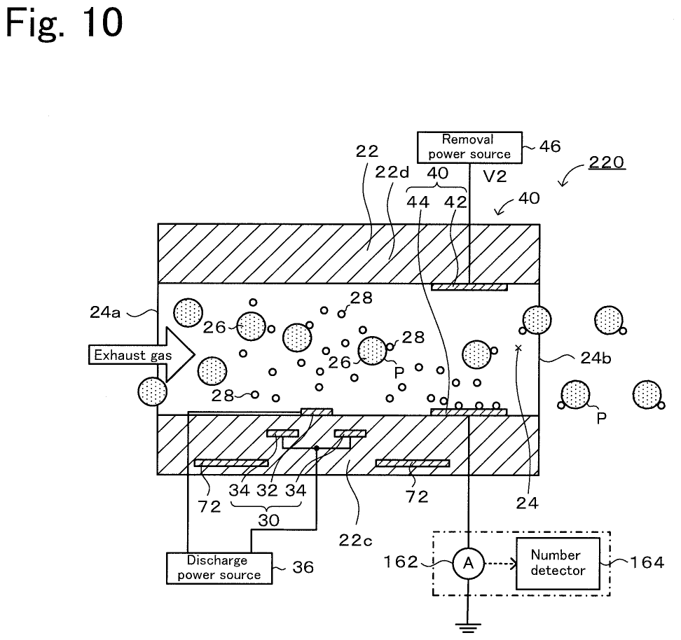

In the first embodiment described above, the number of charged particles P is determined based on the electric current flowing to the collection electrode 54. Alternatively, as in a particle detection element 220 shown in FIGS. 8 to 10, the collector 50 and the guard electrodes 90 and 92 may be omitted, the number of excess electric charge particles may be determined based on an electric current flowing to the removal electrode 44 (i.e., the electric current detected by an ammeter 162), and a number measuring device 164 may determine the number of charged particles P by subtracting the number of excess electric charge particles from the total number of electric charge particles generated by the charge generator 30. In other words, the collection target may be the excess electric charge. FIGS. 8 to 10 are cross-sectional views of the particle detection element 220. FIG. 8 is a cross-sectional view corresponding to FIG. 3, FIG. 9 is a cross-sectional view corresponding to FIG. 4, and FIG. 10 is a cross-sectional view corresponding to FIG. 5. In FIGS. 8 to 10, components identical to those in the first embodiment described above are given the same reference signs. In this case, the charged particles P are discharged from the gas outlet 24b. As shown in FIG. 9, guard electrodes 190 and 192 are provided so as to absorb a leakage current flowing from the application electrode 42 toward the removal electrode 44 via the housing 22. Specifically, the guard electrodes 190 and 192 are provided above and below the removal electrode 44 so as to block an electric current path 196 connecting the application electrode 42 and the removal electrode 44 within the housing 22. Accordingly, the electric current flowing to the removal electrode 44 can be accurately ascertained, whereby the accuracy for detecting the number of particles can be enhanced.

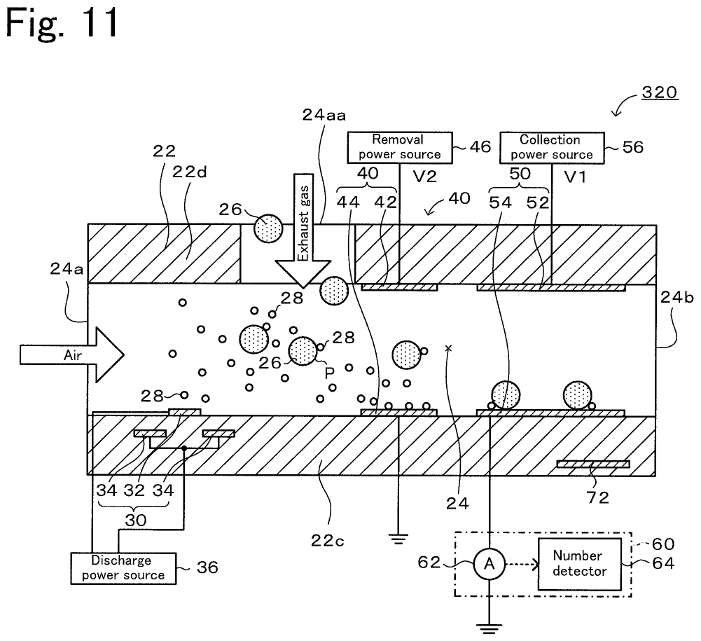

In the first embodiment described above, the gas channel 24 has a single gas inlet 24a. Alternatively, as in a particle detection element 320 shown in FIG. 11, the gas channel 24 may have, in addition to the gas inlet 24a, a gas inlet 24aa that introduces gas between the charge generator 30 and the excess charge remover 40 from a direction orthogonal to the gas channel 24. In FIG. 11, components identical to those in the first embodiment described above are given the same reference signs. In this case, air is introduced from the gas inlet 24a, and exhaust gas is introduced from the gas inlet 24aa. The electric charge 28 is generated in the air in accordance with electric discharge by the charge generator 30. The electric charge 28 is mixed with the particles 26 in the exhaust gas introduced from the gas inlet 24aa so as to attach to the particles 26, whereby the particles 26 become charged particles P. Accordingly, the number of particles can be detected based on the same principle as in the first embodiment described above. The particle detection element 220 shown in FIGS. 8 to 10 may also be provided with two gas inlets in the gas channel 24, as in FIG. 11. Moreover, the gas inlet 24aa may similarly be employed in the second embodiment to be described later.

As an alternative to the first embodiment described above in which the charge generator 30 is constituted of the discharge electrode 32 provided along the inner surface of the gas channel 24 and the two ground electrodes 34, 34 embedded in the housing 22, the charge generator 30 may have any configuration so long as the charge generator 30 generates electric charge by aerial discharge. For example, instead of being embedded in the wall of the gas channel 24, the ground electrodes 34, 34 may be provided along the inner surface of the gas channel 24. Alternatively, the charge generator may be constituted of a needle electrode and a counter electrode, as described in Patent Literature 1. Furthermore, as an alternative to or in addition to the charge generator 30 provided at the channel wall 22c in the first embodiment described above, the charge generator 30 may be provided at the channel wall 22d. Such modifications of the charge generator 30 may similarly be employed in the second embodiment to be described later.

As an alternative to the first embodiment described above in which the counter electrode 52 is exposed in the gas channel 24, the counter electrode 52 may be embedded in the housing 22. The same applies to the application electrode 42.

In the first embodiment described above, the particle detection device 10 is described as being attached to the exhaust pipe 12 of the engine, but is not particularly limited to being attached to the exhaust pipe 12 of the engine. The pipe may be of any type so long as gas containing particles flows through the pipe. The same applies to the second embodiment to be described later.

As an alternative to the first embodiment described above in which the particle detection element 20 detects the number of particles, the particle detection element 20 may detect, for example, the mass or the surface area of the particles. The mass of the particles can be determined by multiplying the number of particles by an average mass of the particles, or can be determined by preliminarily storing the relationship between the accumulative charge amount and the mass of the collected particles as a map in a storage device and determining the mass of the particles from the accumulative charge amount by using this map. The surface area of the particles can also be determined by using a method similar to that for the mass of the particles. The same applies to the second embodiment to be described later.

In the first embodiment described above, the guard electrodes 90 and 92 and the removal electrode 44 may be electrically connected to each other and may be connected to ground via a shared terminal.

In the first embodiment described above, the application electrode 42 and the removal power source 46 may be omitted. Accordingly, without having a dedicated power source for generating an electric field on the removal electrode 44, the removal electrode 44 utilizes an electric field generated between the removal electrode 44 and voltage application electrodes (such as the discharge electrode 32 and the counter electrode 52) disposed in the surrounding area thereof to remove excess electric charge 28 to the ground. Therefore, the configuration of the particle detection device 10 can be simplified, as compared with a case where the removal electrode 44 has a dedicated power source for generating an electric field.

In the first embodiment described above, the guard electrodes 90 and 92 may partially or entirely be exposed at the inner surface of the housing 22. Accordingly, the guard electrodes 90 and 92 can absorb a leakage current flowing from one of the counter electrode 52 and the collection electrode 54 to the other via the inner surface of the housing 22.

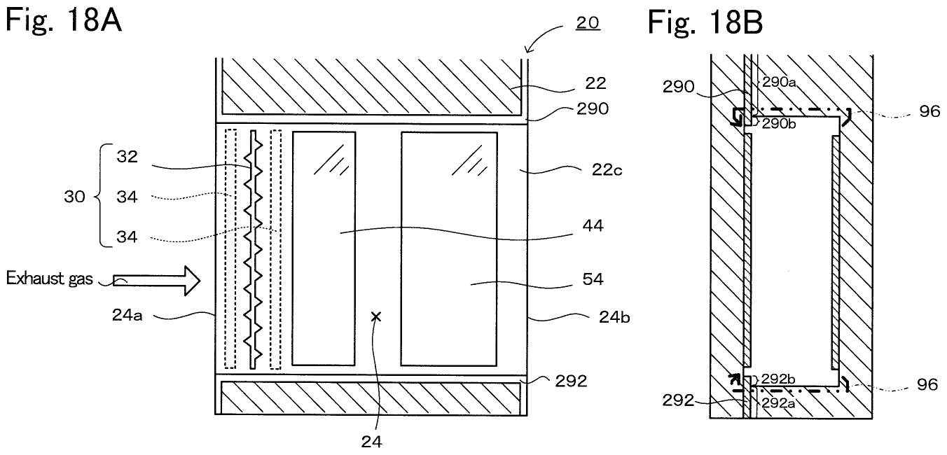

For example, FIGS. 18A and 18B include cross-sectional views of the particle detection element 20 equipped with guard electrodes 290 and 292. FIG. 18A is a cross-sectional view corresponding to the cross-sectional view taken along line A-A in FIG. 2, and FIG. 18B is a cross-sectional view corresponding to the cross-sectional view taken along line B-B in FIG. 2. In FIGS. 18A and 18B, components identical to those in the first embodiment described above are given the same reference signs. The guard electrodes 290 and 292 are provided in the same plane as the collection electrode 54 and extend from the interior of the housing 22 (i.e., the part composed of the ceramic material) to the inner surface of the housing 22 (i.e., the surface exposed in the gas channel 24). In detail, the guard electrodes 290 and 292 respectively include embedded sections 290a and 292a embedded in the housing 22 and exposed sections 290b and 292b disposed at the inner surface of the housing 22. The guard electrodes 290 and 292 can absorb both a leakage current flowing through the interior of the housing 22 and a leakage current flowing along the inner surface of the housing 22. The guard electrode 290 and the guard electrode 292 are provided at a position above the collection electrode 54 and a position below the collection electrode, respectively, and extend from the gas inlet 24a of the gas channel 24 to the gas outlet 24b. Accordingly, since the guard electrodes 290 and 292 are not disposed in front of or behind the collection electrode 54, the collection electrode 54 can be increased in size and can collect a larger number of charged particles P, as compared with a case where guard electrodes are provided to surround the entire periphery of the collection electrode 54. Thus, the measurement sensitivity is enhanced.

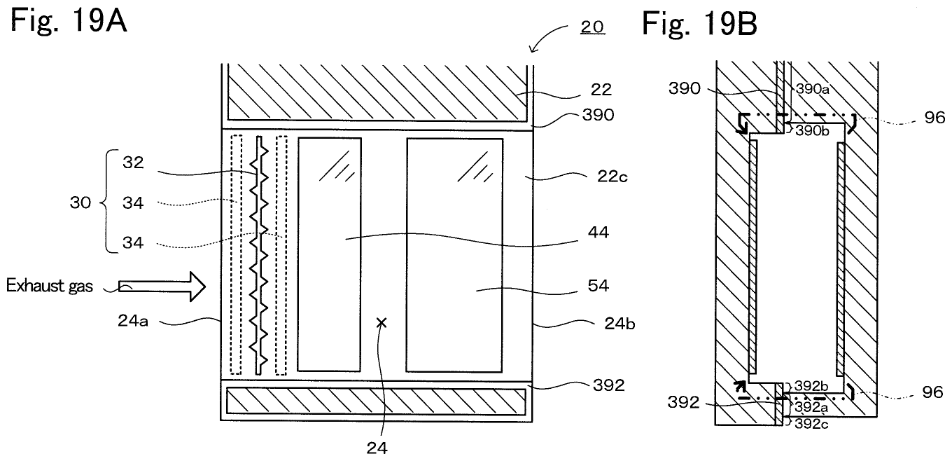

FIGS. 19A and 19B include cross-sectional views of the particle detection element 20 equipped with guard electrodes 390 and 392. FIG. 19A is a cross-sectional view corresponding to the cross-sectional view taken along line A-A in FIG. 2, and FIG. 19B is a cross-sectional view corresponding to the cross-sectional view taken along line B-B in FIG. 2. In FIGS. 19A and 19B, components identical to those in the first embodiment described above are given the same reference signs. The guard electrodes 390 and 392 are provided at stepped surfaces that are included in the inner surface of the housing 22 and that are different from the surface where the collection electrode 54 is provided. The guard electrode 390 is provided from the interior of the housing 22 to the inner surface of the housing 22. In detail, the guard electrode 390 includes an embedded section 390a embedded in the housing 22 and an exposed section 390b disposed at the inner surface of the housing 22. On the other hand, the guard electrode 392 is provided from the interior of the housing 22 to the inner surface of the housing 22 and to the outer surface of the housing 22 (i.e., the surface at the outer side of the housing 22). In detail, the guard electrode 392 includes an embedded section 392a embedded in the housing 22, an exposed section 392b disposed at the inner surface of the housing 22, and an exposed section 392c disposed at the outer surface of the housing 22. The guard electrodes 390 and 392 can absorb both a leakage current flowing through the interior of the housing 22 and a leakage current flowing along the inner surface of the housing 22. In particular, because the guard electrode 392 is equipped with the exposed section 392c disposed at the outer surface of the housing 22, the guard electrode 392 can absorb a leakage current more reliably. The guard electrode 390 and the guard electrode 392 are provided at a position above the collection electrode 54 and a position below the collection electrode, respectively, and extend from the gas inlet 24a of the gas channel 24 to the gas outlet 24b. Accordingly, since the guard electrodes 390 and 392 are not disposed in front of or behind the collection electrode 54, the collection electrode 54 can be increased in size and can collect a larger number of charged particles P, as compared with a case where guard electrodes are provided to surround the entire periphery of the collection electrode 54. Thus, the measurement sensitivity is enhanced. In addition, because the guard electrodes 390 and 392 are provided at stepped surfaces different from the surface where the collection electrode 54 is provided, even if particles adhere to a surrounding area of the collection electrode 54, the particles are less likely to cause a short circuit to occur between the collection electrode 54 and the guard electrodes 390 and 392.

Similar to the guard electrode 292, the guard electrode 392 in FIGS. 19A and 19B may be provided from the interior of the housing 22 to the inner surface of the housing 22 (i.e., the exposed section 392c may be omitted). Moreover, similar to the guard electrode 392, the guard electrode 292 in FIGS. 18A and 18B may be provided from the interior of the housing 22 to the inner surface of the housing 22 and to the outer surface of the housing 22.

In the first embodiment described above, the right channel wall 22d of the housing 22 is provided with the application electrode 42 of the excess charge remover 40 and the counter electrode 52 of the collector 50, and the left channel wall 22c is provided with the removal electrode 44 of the excess charge remover 40 and the collection electrode 54 of the collector 50. However, the configuration is not particularly limited to this. For example, the left channel wall 22c of the housing 22 may be provided with the application electrode 42 of the excess charge remover 40 and the counter electrode 52 of the collector 50, and the right channel wall 22d may be provided with the removal electrode 44 of the excess charge remover 40 and the collection electrode 54 of the collector 50. In that case, the application electrode 42 may be omitted, and an electric field generated between the removal electrode 44 and voltage application electrodes (such as the discharge electrode 32 and the counter electrode 52) disposed in the surrounding area thereof may be utilized to collect excess electric charge 28 to the removal electrode 44 and to remove the excess electric charge 28 to the ground.

### Second Embodiment

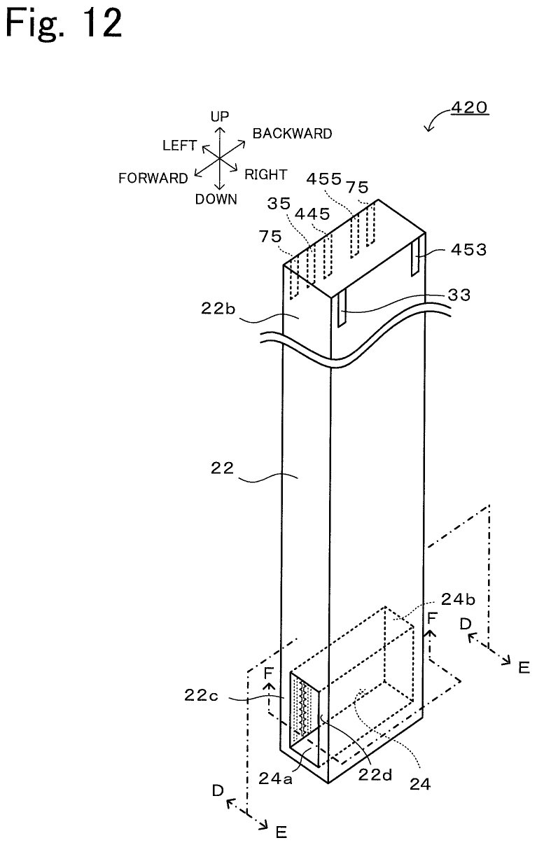

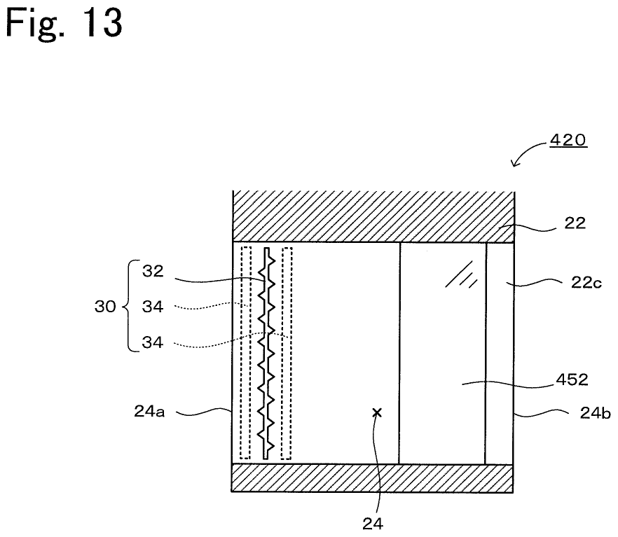

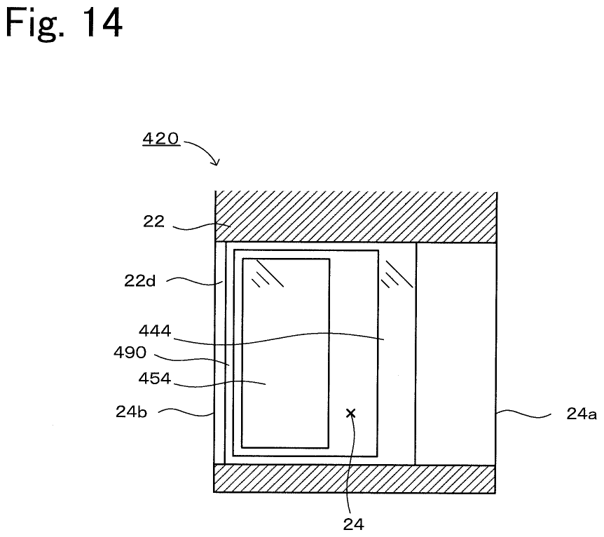

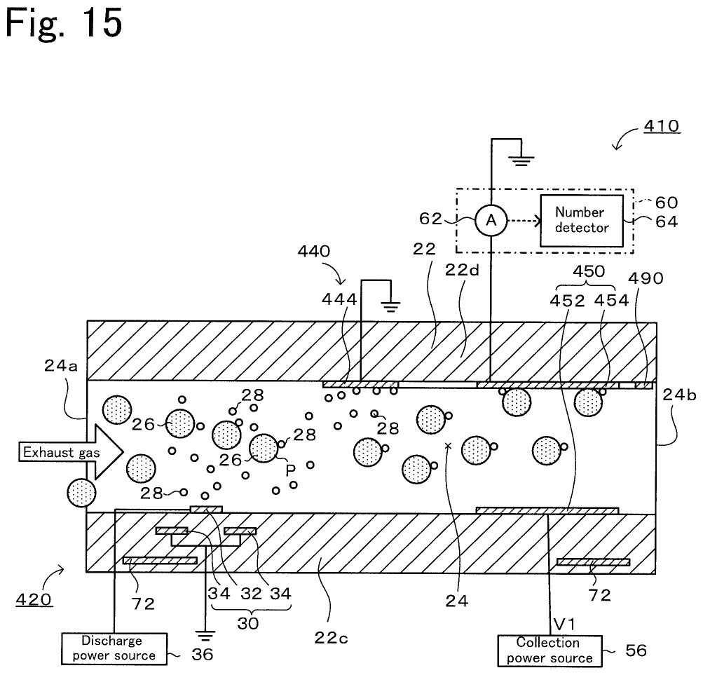

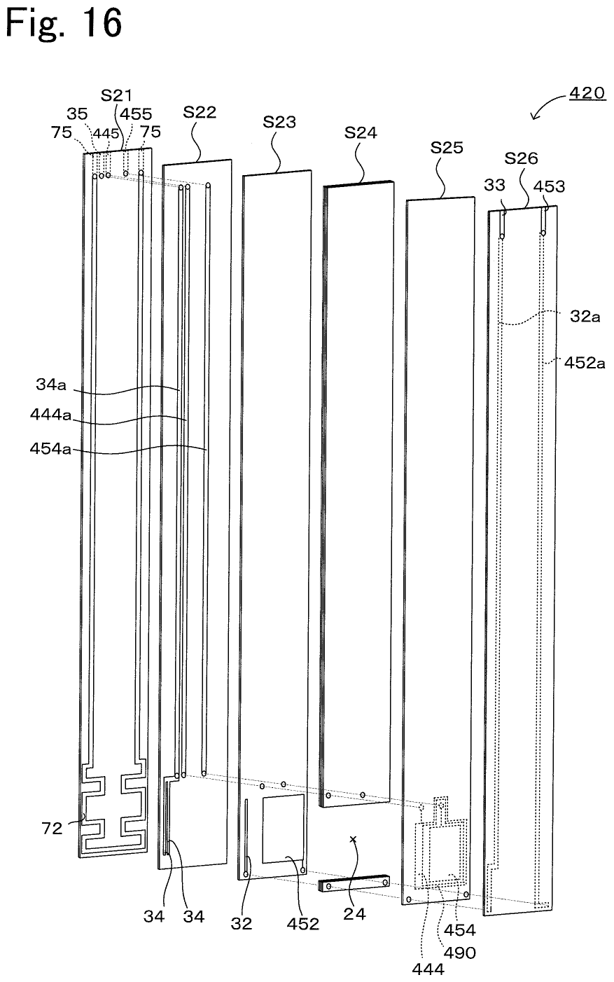

The second embodiment of the present invention will be described with reference to the drawings. A particle detection device 410 according to the second embodiment is identical to the particle detection device 10 according to the first embodiment except for being equipped with a particle detection element 420 in place of the particle detection element 20 of the particle detection device 10 and not being equipped with the removal power source 46, which is one of the components of the accessory unit 80. Therefore, the following description mainly relates to the particle detection element 420. FIG. 12 is a perspective view of the particle detection element 420, FIG. 13 is a cross-sectional view taken along line D-D in FIG. 12, FIG. 14 is a cross-sectional view taken along line E-E in FIG. 12, FIG. 15 is a cross-sectional view taken along line F-F in FIG. 12, and FIG. 16 is an exploded perspective view of the particle detection element 420. In the second embodiment, components identical to those in the first embodiment will be described by being given the same reference signs.

As shown in FIG. 15, in the housing 22, the particle detection element 420 includes the charge generator 30, an excess charge remover 440, a collector 450, a guard electrode 490, and the heater electrode 72. Descriptions of the housing 22, the charge generator 30, and the heater electrode 72 will be omitted here since they are identical to those in the first embodiment. As shown in FIG. 15, the number detector 60, which is one of the components of the accessory unit 80, is identical to the number detector 60 in the first embodiment except that one of the terminals of the ammeter 62 is connected to a collection electrode 454. Therefore, the description of the number detector 60 will be omitted here.

As shown in FIG. 15, the excess charge remover 440 is provided downstream of the charge generator 30 and upstream of the collector 450. The excess charge remover 440 has a removal electrode 444 (see FIG. 14) but does not have an application electrode. The removal electrode 444 is provided along the inner surface of the right channel wall 22d and is exposed within the gas channel 24. The removal electrode 444 is connected to ground.

As shown in FIG. 15, the collector 450 is provided downstream of the charge generator 30 and the excess charge remover 440 in the gas channel 24. The collector 450 collects the charged particles P and has a counter electrode (electric-field generating electrode) 452 and the collection electrode 454. The counter electrode 452 is provided along the inner surface of the left channel wall 22c and is exposed within the gas channel 24 (see FIG. 13). The collection electrode 454 is provided along the inner surface of the right channel wall 22d and is exposed within the gas channel 24 (see FIG. 14). The counter electrode 452 and the collection electrode 454 are disposed at positions facing each other. The counter electrode 452 receives a direct-current voltage V1 (positive potential of about 2 kV) from the collection power source 56. The collection electrode 454 is connected to ground via the ammeter 62. Accordingly, a relatively strong electric field is generated between the counter electrode 452 and the collection electrode 454 of the collector 450. Therefore, the charged particles P flowing through the gas channel 24 are collected by being drawn to the collection electrode 454 by this relatively strong electric field. The counter electrode 452 may be exposed in the gas channel 24 or may be embedded in the housing 22.

The size of the removal electrode 444 of the excess charge remover 440, the intensity of the electric field between the discharge electrode 32 and the removal electrode 444, the sizes of the electrodes 452 and 454 of the collector 450, the intensity of the electric field generated between the electrodes 452 and 454, the distance between the removal electrode 444 and the discharge electrode 32, and the distance between the removal electrode 444 and the counter electrode 452 are set such that the charged particles P are collected by the collection electrode 454 without being collected by the removal electrode 444 and such that the electric charge 28 not added to the particles 26 is removed by the removal electrode 444. Normally, these settings are easily possible since the degree of electrical migration of the electric charge 28 is 10 or more times the degree of electrical migration of the charged particles P and the electric field required for the collection may be smaller by one or more digits.

The guard electrode 490 serves as a leakage-current absorbing electrode that absorbs a leakage current flowing from the counter electrode 452 toward the collection electrode 454 via the surface of the housing 22. As shown in FIGS. 14 and 15, the guard electrode 490 is provided at the surface of the channel wall 22d so as to surround the collection electrode 454. A part of the guard electrode 490 is integrated with the removal electrode 444. The guard electrode 490 is connected together with the removal electrode 444 to the ground via a removal-electrode terminal 445 (see FIGS. 12 and 16). Although the collection electrode 454 is indicated as being rectangular and the guard electrode 490 has a shape surrounding the rectangle for the sake of convenience in FIG. 14, since a terminal-connection extension section is actually provided at an upper part of the collection electrode 454, as shown in FIG. 16, an upper part of the guard electrode 490 has a shape that also surrounds this extension section.

The configuration of the particle detection element 420 will be further described by using the exploded perspective view in FIG. 16. The particle detection element 420 is constituted of six sheets S21 to S26. The sheets S21 to S26 are composed of the same material as the housing 22. For the sake of convenience, the sheets will be referred to as a first sheet S21, a second sheet S22, and so on from left to right, and the right face and the left face of each of the sheets S21 to S26 will be referred to as a front face and a rear face, respectively. The sheets S21 to S26 may each have an appropriately-set thickness. For example, the thickness may be the same among the sheets or may vary among the sheets.

The front face of the first sheet S21 is provided with the heater electrode 72. One end and the other end of the heater electrode 72 are disposed at the upper side of the front face of the first sheet S21, and are respectively connected to the heater-electrode terminals 75, 75 provided at the upper side of the rear face of the first sheet S21 via through-holes in the first sheet S21.

The front face of the second sheet S22 is provided with the ground electrodes 34, 34. The ground electrodes 34, 34 are bundled into a single wire 34a. An end of the wire 34a is disposed at the upper side of the front face of the second sheet S22, and is connected to the ground-electrode terminal 35, provided at the upper side of the rear face of the first sheet S21, via through-holes in the second sheet S22 and the first sheet S21. The front face of the second sheet S22 is provided with a wire 444a of the removal electrode 444 and a wire 454a of the collection electrode 454 in the up-down direction. The upper ends of the wires 444a and 454a are respectively connected to the removal-electrode terminal 445 and a collection-electrode terminal 455, provided at the upper side of the rear face of the first sheet S21, via through-holes in the second sheet S22 and the first sheet S21.

The front face of the third sheet S23 is provided with the discharge electrode 32 and the counter electrode 452.

The lower end of the fourth sheet S24 is provided with the gas channel 24, that is, a rectangular-cuboid-shaped space.

The rear face of the fifth sheet S25 is provided with the removal electrode 444, the collection electrode 454, and the guard electrode 490. The removal electrode 444 integrated with the guard electrode 490 is connected to the wire 444a in the second sheet S22 via through-holes in the fourth sheet S24 and the third sheet S23, and is connected to the removal-electrode terminal 445 via this wire 444a. The collection electrode 454 is connected to the wire 454a in the second sheet S22 via through-holes in the fourth sheet S24 and the third sheet S23, and is connected to the collection-electrode terminal 455 via this wire 454a.

The rear face of the sixth sheet S26 is provided with the wire 32a of the discharge electrode 32 and a wire 452a of the counter electrode 452 in the up-down direction. The lower end of the wire 32a is connected to the discharge electrode 32 provided in the third sheet S23 via through-holes in the fourth and fifth sheets S24 and S25. The lower end of the wire 452a is connected to the counter electrode 452 provided in the third sheet S23 via through-holes in the fourth and fifth sheets S24 and S25. The upper ends of the wires 32a and 452a are respectively connected to the discharge-electrode terminal 33 and a counter-electrode terminal 453, provided at the upper side of the front face of the sixth sheet S26, via through-holes in the sixth sheet S26.

Next, an example of how the particle detection device 410 is manufactured will be described. The particle detection element 420 can be fabricated by using a plurality of ceramic green sheets. In detail, after forming cutouts, through-holes, and grooves in the plurality of ceramic green sheets and screen-printing electrodes and wiring patterns thereon, where appropriate, the ceramic green sheets are stacked and baked. The cutouts, the through-holes, and the grooves may be formed by filling in a material (such as an organic material) that burns out during the baking process. The particle detection element 420 is obtained in this manner. Subsequently, the discharge-electrode terminal 33 and the counter-electrode terminal 453 of the particle detection element 420 are respectively connected to the discharge power source 36 and the collection power source 56 of the accessory unit. The ground-electrode terminal 35 and the removal-electrode terminal 445 of the particle detection element 420 are connected to ground, and the collection-electrode terminal 455 is connected to the number measuring device 64 via the ammeter 62. Furthermore, the heater-electrode terminals 75, 75 are connected to the electricity feeder (not shown). The particle detection device 410 can be manufactured in this manner.

Next, an example of how the particle detection device 410 is used will be described. In a case where particles 26 contained in exhaust gas of an automobile are to be measured, the particle detection element 420 is attached to the exhaust pipe 12 of the engine, similar to the particle detection element 20 according to the first embodiment shown in FIG. 1. As shown in FIG. 15, the particles 26 contained in the exhaust gas introduced into the gas channel 24 from the gas inlet 24a are charged by the electric charge 28 (i.e., positive electric charge) generated in accordance with electric discharge by the charge generator 30, so as to become charged particles P. The charged particles P have a weak electric field (i.e., an electric field generated between the removal electrode 444 and voltage application electrodes (such as the discharge electrode 32 and the counter electrode 452) disposed in the surrounding area thereof) and pass through the excess charge remover 440 in which the removal electrode 444 is shorter than the collection electrode 454, so as to reach the collector 450. On the other hand, electric charge 28 not added to the particles 26 has a weak electric field but is still drawn toward the removal electrode 444 of the excess charge remover 440, so as to be discarded to the ground via the removal electrode 444. Consequently, most of the unwanted electric charge 28 not added to the particles 26 do not reach the collector 450. The charged particles P reaching the collector 450 are collected by the collection electrode 454 in accordance with a collection electric field generated by the counter electrode 452. Then, the ammeter 62 measures the electric current of the charged particles P collected by the collection electrode 454 based on the electric charge 28, and the number measuring device 64 calculates the number Nt of particles 26 based on the electric current in a manner similar to the first embodiment. Similar to the first embodiment, the particle detection element 420 refreshes the collection electrode 454 and the inner peripheral surface of the housing 22 by heating them using the heater electrode 72 at an appropriate timing.

Next, the function of the guard electrode 490 will be described. When the number Nt is to be detected in the particle detection device 410, a voltage V1 is applied between the counter electrode 452 and the collection electrode 454 of the collector 450. Because the voltage V1 is several kV, a leakage current of several tens to several hundreds of pA flows from one of the counter electrode 452 and the collection electrode 454 to the other via the housing 22, even if the housing 22 is composed of a ceramic material, such as alumina, normally considered to be an electrical insulator. Meanwhile, when the number Nt is to be detected, a detection current measured by the ammeter 62 is several pA. Therefore, the leakage current has an effect on the detection current. In this embodiment, the guard electrode 490 absorbs this leakage current and discards the leakage current to the ground. Consequently, the detection current that changes in accordance with the charged particles P collected by the collection electrode 454 can be accurately ascertained.

In the particle detection device 410 described above, the leakage current flowing from the counter electrode 452 toward the collection electrode 454 via the surface of the housing 22 has an effect on the detection current that changes in accordance with the charged particles P collected by the collection electrode 454, but is absorbed by the guard electrode 490. Therefore, the detection current can be accurately ascertained, whereby the accuracy for detecting the number of particles can be enhanced.

Furthermore, since the guard electrode 490 is connected to ground, the leakage current can be reliably discharged outside.

Moreover, the guard electrode 490 is provided at the same surface as the collection electrode 454 so as to surround the collection electrode 454. Therefore, a leakage current flowing along the inner surface of the housing 22 can be reliably prevented from flowing to the collection electrode 454.

Furthermore, since the collection target to be collected is the charged particles P, the voltage V1 to be applied between the counter electrode 452 and the collection electrode 454 needs to be high, as compared with a case where the collection target is excess electric charge. Thus, the leakage current flows readily from the counter electrode 452 toward the collection electrode 454 via the housing 22, and there is great significance in absorbing the leakage current by using the guard electrode 490.

Because the guard electrode 490 is integrated with the removal electrode 444, the configuration of the electrodes can be simplified.

Furthermore, without having a dedicated power source for generating an electric field on the removal electrode 444, the removal electrode 444 utilizes an electric field generated between the removal electrode 444 and voltage application electrodes (such as the discharge electrode 32 and the counter electrode 452) disposed in the surrounding area thereof to discard excess electric charge 28 to the ground. Therefore, the configuration of the particle detection device 410 can be simplified, as compared with a case where the removal electrode 444 has a dedicated power source for generating an electric field.

Needless to say, the present invention is not limited in any way to the second embodiment described above and may be implemented in various modes within the technical scope of the invention.

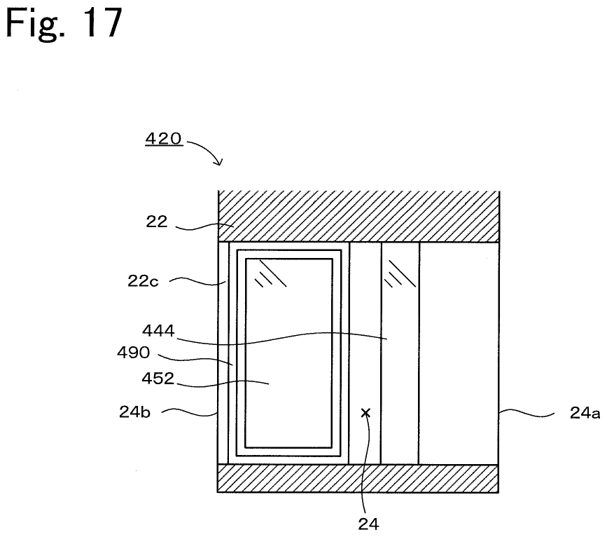

For example, as an alternative to the second embodiment described above in which the guard electrode 490 and the removal electrode 444 are integrated with each other, the guard electrode 490 and the removal electrode 444 may be provided independently of each other, as shown in FIG. 17 (corresponding to the cross-sectional view taken along E-E in FIG. 12). In that case, the electrodes 490 and 444 may be connected to ground via a shared wire, or may be connected to ground via individual wires.

As an alternative to the second embodiment described above in which the excess charge remover 440 is described as not having an application electrode or a dedicated removal power source that applies a voltage to the application electrode, the excess charge remover 440 may have an application electrode provided at a position facing the removal electrode 444 and a removal power source connected to the application electrode, similar to the first embodiment.

In the second embodiment described above, the right channel wall 22d of the housing 22 is provided with the removal electrode 444 of the excess charge remover 440 and the collection electrode 454 and the guard electrode 490 of the collector 450, and the left channel wall 22c is provided with the counter electrode 452 of the collector 50. However, the configuration is not particularly limited to this. For example, the left channel wall 22c of the housing 22 may be provided with the removal electrode 444, the collection electrode 454, and the guard electrode 490, and the right channel wall 22d may be provided with the counter electrode 452 of the collector 50.

As an alternative to the second embodiment described above in which the right channel wall 22d of the housing 22 is provided with the removal electrode 444 of the excess charge remover 440, the left channel wall 22c may also be provided with a removal electrode connected to ground.

The present application claims priority from Japanese Patent Application No. 2018-021097 filed on Feb. 8, 2018, and Japanese Patent Application No. 2018-175737 filed on Sep. 20, 2018, the entire contents of which are incorporated herein by reference.

What is claimed is:

1. A particle detection device used for detecting particles in gas, the particle detection device comprising:
a housing having a gas channel through which the gas passes;
a charge generator that adds electric charge generated in accordance with electric discharge to the particles in the gas introduced into the gas channel so as to turn the particles into charged particles;
a collector that is provided downstream, in a flow of the gas, of the charge generator within the gas channel and that collects a collection target, the collection target being either of the charged particles or excess electric charge that has not charged the particles; and
a detector that detects an amount of the particles based on a physical amount that changes in accordance with the collection target collected by the collector,
wherein the collector has a collection electrode exposed in the gas channel and a counter electrode facing the collection electrode with the gas channel interposed therebetween, and collects the collection target onto the collection electrode by utilizing an electric field generated between the collection electrode and the counter electrode in the gas channel by applying a voltage between the collection electrode and the counter electrode, and
wherein the housing has a leakage-current absorbing electrode that absorbs a leakage current flowing from one of the collection electrode and the counter electrode to the other one of the collection electrode and the counter electrode via the housing.

2. The particle detection device according to claim 1,
wherein the leakage-current absorbing electrode is connected to ground.

3. The particle detection device according to claim 1,
wherein the leakage-current absorbing electrode is provided so as to block an electric current path connecting the collection electrode and the counter electrode within the housing.

4. The particle detection device according to claim 3,
wherein at least a part of the electric current path is composed of a ceramic material, and
wherein the leakage-current absorbing electrode is provided at the part composed of the ceramic material.

5. The particle detection device according to claim 4,
wherein the leakage-current absorbing electrode is provided from the part composed of the ceramic material to an inner surface of the housing, or is provided from the part composed of the ceramic material to the inner surface of the housing and to an outer surface of the housing.

6. The particle detection device according to claim 5,
wherein the leakage-current absorbing electrode is provided at a surface that is included in the inner surface of the housing and that is different from a surface where the collection electrode is provided.

7. The particle detection device according to claim 1,
wherein the leakage-current absorbing electrode is provided at an inner surface of the housing.

8. The particle detection device according to claim 7,
wherein the leakage-current absorbing electrode is provided at the same surface as the collection electrode such that the leakage-current absorbing electrode surrounds the collection electrode.

9. The particle detection device according to claim 7,
wherein the leakage-current absorbing electrode is provided at a surface that is included in the inner surface of the housing and that is different from a surface where the collection electrode is provided.

10. The particle detection device according to claim 1,
wherein the leakage-current absorbing electrode is provided at positions above and below the collection electrode and extends from a gas inlet to a gas outlet of the gas channel.

11. The particle detection device according to claim 1,
wherein the collection target is the charged particles.

12. The particle detection device according to claim 11, further comprising:
a removal electrode that is provided between the charge generator and the collector within the gas channel and that removes the excess electric charge that has not charged the particles to ground,
wherein the leakage-current absorbing electrode is integrated with the removal electrode.

13. The particle detection device according to claim 12,
wherein the removal electrode does not have a dedicated power source that generates an electric field on the removal electrode, and removes the excess electric charge to the ground by utilizing an electric field generated between the removal electrode and a voltage application electrode disposed in a surrounding area of the removal electrode.

14. The particle detection device according to claim 13,
wherein the voltage application electrode is a discharge electrode that receives a voltage applied by a discharge power source in the charge generator, or is the counter electrode that receives a voltage applied by a collection power source in the collector.
